(19) United States
(12) Patent Application Publication
(10) Pub. No.: US 2012/0078389 A1
(43) Pub. Date: Mar. 29, 2012

(54) COMMUNICATION SYSTEM AND CONTROL METHOD THEREFOR

(75) Inventor: Minoru Hashimoto, Chigasaki-shi (JP)

(73) Assignee: CANON KABUSHIKI KAISHA, Tokyo (JP)

(21) Appl. No.: 13/225,917

(22) Filed: Sep. 6, 2011

(30) Foreign Application Priority Data
Sep. 29, 2010 (JP) 2010-219764

(51) Int. Cl. G06F 1/26

(52) U.S. Cl. 700/22

(57) ABSTRACT

A communication system according to the present invention includes a server and a plurality of apparatus. Each of the apparatuses controls a state of power supply to a device integrated in the apparatus in accordance with an instruction from the server. The server assigns one of a plurality of time slots that are repeated periodically to each of the apparatuses, and notifies each of the apparatuses of information indicating the assigned time slot. Each of the apparatuses, if a pre-set criterion for each of the apparatuses to turn on power supply to the device is satisfied, turns on power supply to the device when the time slot notified by the server is reached.

### BACKGROUND OF THE INVENTION

1. Field of the Invention

The present invention relates to a communication system that prevents the occurrence timings of inrush current in multiple apparatuses from overlapping, and a control method therefor.

2. Description of the Related Art

Conventionally, an apparatus such as a multi-function peripheral (MFP), a printer, or a facsimile (FAX) that employs an electrophotographic method and requires heat in forming an image is configured to adjust the temperature of a heater by controlling the on/off power state of the power supply to the heater based on predetermined criteria. As the simplest example of such control, power supply to a heater is turned off if a value detected by a temperature sensor exceeds a fixed value, whereas power supply to the heater is turned on if the value is lower than a fixed value. In the case of a typical MFP, a cycle between turning on and off the power supply to a heater is in the order of several seconds to several ten seconds.

Here, there are cases where a high current called an “inrush current” flows into a heater for a short period of time after turning on power supply to the heater. In large offices or the like where a large number of apparatuses are running, the timing of turning on power supply to a heater is set individually for each apparatus. In this case, there is a problem in that if the timings of turning on power supply to heaters happen to coincide in multiple apparatuses, a high current may flow into power supply equipment in an office. For an MFP having multiple internal heaters, there is a technique in which the timings of turning on power supply to heaters are staggered so as to prevent the timings of turning on power supply to multiple heaters from overlapping (Japanese Patent Laid-Open No. 10-186940). With this technique, the occurrence timings of inrush current in multiple heaters are prevented from overlapping by turning on power supply to multiple heaters one by one with a predetermined time lag.

However, the technique disclosed in Japanese Patent Laid-Open No. 10-186940 relates to controlling the timings of turning on power supply to multiple heaters that are mounted on a single apparatus, and therefore it gives no consideration to the problem that high current consumption may occur due to the overlap of the timings at which power supply to heaters in multiple apparatuses is turned on. Furthermore, even if the timings at which apparatuses turn on power supply to heaters are attempted to be staggered by a predetermined amount of time for each apparatus so as to prevent the timings of turning on power supply to heaters in multiple apparatuses from overlapping, the timing at which each apparatus turns on power supply to a heater varies depending on the operating status or the like of the apparatus. For this reason, it is difficult to prevent the timings of turning on power supply to heaters in multiple apparatuses from overlapping.

### SUMMARY OF THE INVENTION

The present invention has been conceived in view of the above problems and enables, in a communication system that includes a server and a plurality of apparatuses, overlapping of the occurrence timings of inrush current flowing into devices of the apparatuses to be reduced by each apparatus controlling the state of power supply to its own device in accordance with an instruction from the server.

According to one aspect of the present invention, there is provided a communication system that includes a server and a plurality of apparatuses and in which each of the plurality of apparatuses controls, in accordance with an instruction from the server, a state of power supply to a device integrated in the apparatus, the server comprising: an assignment unit that assigns one of a plurality of time slots that are repeated periodically to each of the plurality of apparatuses, and a notification unit that notifies each of the plurality of apparatuses of information indicating the time slot assigned by the assignment unit, and each of the plurality of apparatuses comprising: a control unit that, in a case where a pre-set criterion for each of the plurality of apparatuses to turn on power supply to the device is satisfied and where a time slot in which the criterion has been satisfied is the time slot notified by the notification unit, turns on power supply to the device upon satisfaction of the criterion, and in a case where the criterion is satisfied and where the time slot in which the criterion has been satisfied is not the notified time slot, turns on power supply to the device upon reaching the notified time slot after satisfaction of the criterion.

According to another aspect of the present invention, there is provided a control method for a communication system that includes a server and a plurality of apparatuses and in which each of the plurality of apparatuses controls, in accordance with an instruction from the server, a state of power supply to a device integrated in the apparatus, the method comprising: in the server, assigning one of a plurality of time slots that are repeated periodically to each of the plurality of apparatuses, and notifying each of the plurality of apparatuses of information indicating the assigned time slot assigned in the assigning, and in each of the plurality of apparatuses, in a case where a pre-set criterion for each of the plurality of apparatuses to turn on power supply to the device is satisfied and where a time slot in which the criterion has been satisfied is the time slot notified in the notifying, turning on power supply to the device upon satisfaction of the criterion, and in a case where the criterion is satisfied and where the time slot in which the criterion has been satisfied is not the notified time slot, turning on power supply to the device upon reaching the notified time slot after satisfaction of the criterion.

The present invention enables, in a communication system that includes a server and a plurality of apparatuses, reducing overlapping of the occurrence timings of inrush current flowing into devices of the apparatuses by each apparatus controlling the state of power supply to its own device in accordance with an instruction from the server.

Further features of the present invention will become apparent from the following description of exemplary embodiments with reference to the attached drawings.

### BRIEF DESCRIPTION OF THE DRAWINGS

FIG. 1 is a diagram showing an overall configuration of a communication system according to Embodiment 1 of the present invention.

FIG. 2 is a block diagram showing an internal configuration of an MFP 104.

FIG. 3 is a block diagram showing a configuration of a main controller 202 of the MFP 104.

FIG. 4 is a graph showing the transition of the temperature of a heater 207 over time and the transition of the current flowing in the heater 207 over time.

FIG. 5 is a graph showing the transition of the temperature of the heater 207 with time and the transition of the current flowing in the heater 207 with time in the MFP 104 and an MFP 105.

FIG. 6 is a graph showing the transition of the temperature of a heater with time and the transition of the current flowing in the heater with time in a case where the timings at which MFPs turn on power supply to heaters are staggered.

FIG. 7 is a diagram showing an example of a management table.

FIG. 8 is a flowchart showing a processing procedure for a communication task performed by a server 100.

FIG. 9 is a flowchart showing a processing procedure for a management table update task performed by the server 100.

FIG. 10 is a flowchart showing a processing procedure for a communication task performed by an MFP.

FIG. 11 is a flowchart showing a processing procedure for a heater control task performed by an MFP.

FIG. 12 is a diagram showing an example of a management table according to Embodiment 2 of the present invention.

FIG. 13 is a flowchart showing a processing procedure for a communication task performed by the server 100 according to Embodiment 3 of the present invention.

### DESCRIPTION OF THE EMBODIMENTS

Hereinafter, exemplary embodiments of the present invention will be described in detail with reference to the drawings. Note that the exemplary embodiments described below are not intended to limit the scope of the present invention, and that not all combinations of the features described in the exemplary embodiments are essential to the means of solving the problem of the present invention.

### Embodiment 1

The description of the present embodiment takes the example of a case where a server designates a time slot in which power supply to a heater included in each MFP is allowed to be turned on.

System Configuration

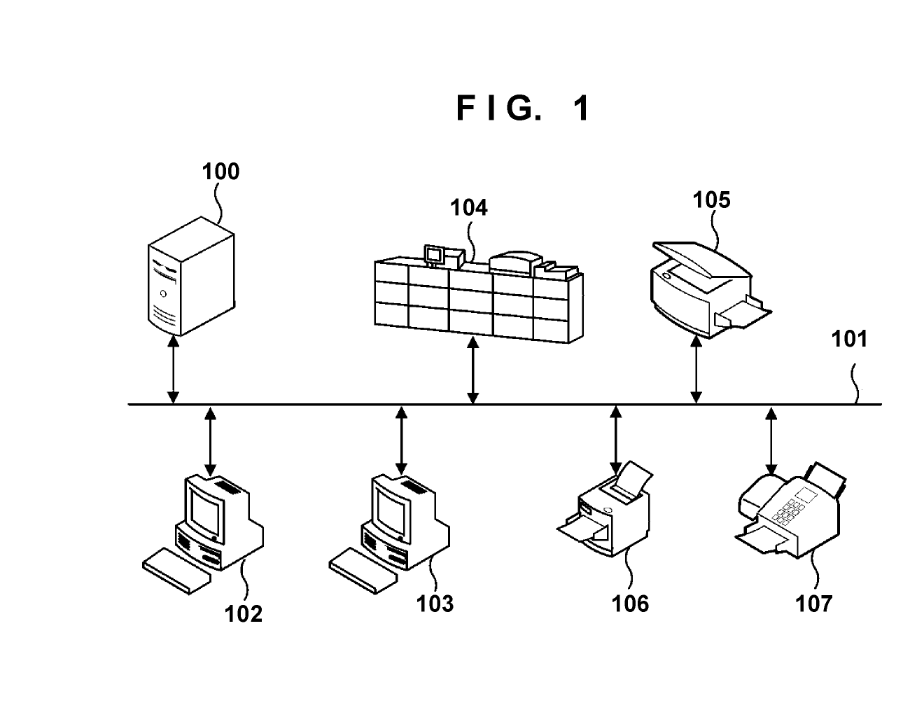

Overall Configuration (FIG. 1)

A communication system according to the present embodiment includes a server 100, PCs 102 and 103, MFPs 104 and 105, a printer 106, and a FAX 107. These apparatuses are connected to a network 101. The server 100 controls the state of power supply to a device integrated in each of the apparatuses including the MFPs 104 and 105, the printer 106, and the FAX 107. The PCs 102 and 103 are used by a user and capable of transmitting and receiving data to and from the MFPs 104 and 105, the printer 106, the FAX 107, and other apparatuses. The MFPs 104 and 105 are apparatuses configured by combining the functions of, for example, a copier, a FAX, a printer, and a scanner. The MFPs 104 and 105 vary greatly in, for example, print speed and whether or not they support color functions, and accordingly have very different power consumption. In particular, with a printer that employs a method of heat-fixing toner (electrophotographic method), a heater requires a large amount of electric power. Furthermore, a color printer has higher power consumption than a monochrome printer, and the power consumption increases with increasing print speed. The printer 106 and the FAX 107 are each an apparatus having a single function. For the sake of simplification, the following description takes the example of a case where the present invention is applied to the MFP 104, although the present invention is also applicable to the MFP 105, the printer 106, and the FAX 107.

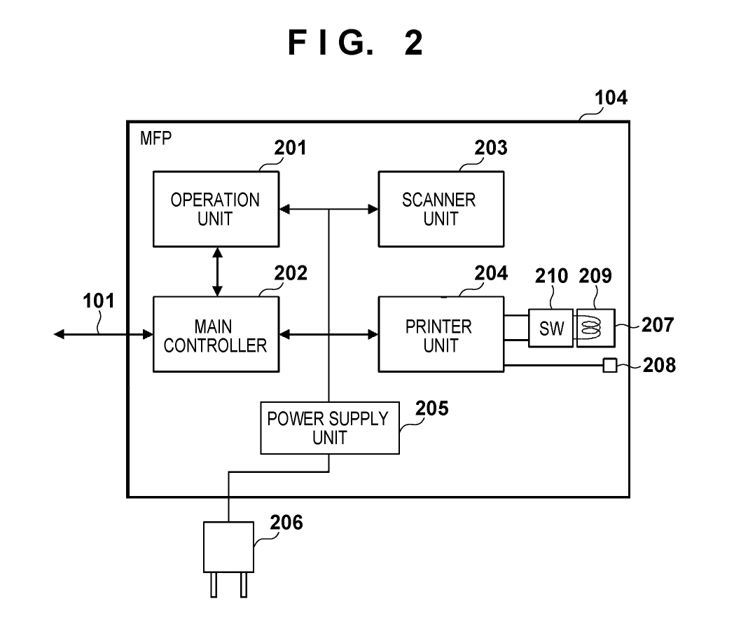

Internal Configuration of MFP (FIG. 2)

The MFP 104 includes an operation unit 201, a main controller 202, a scanner unit 203, a printer unit 204, and a power supply unit 205. The main controller 202 controls the operation of the MFP 104 to perform processing such as data transmission and reception, data conversion, data storage, and power control.

In a case where the MFP 104 executes a print function, job data is generated by the PC 102 or 103. The generated job data is transferred to the main controller 202 via the network 101 and is temporarily stored in the main controller 202. Then, the main controller 202 converts the stored job data into image data and transfers the converted data to the printer unit 204 (image forming unit). The printer unit 204 prints an image based on the image data on recording paper and discharges the printed paper outside the apparatus under the control of the main controller 202. The printer unit 204 includes a heater 207 for fixing toner on recording paper at a high temperature. The main controller 202 controls the temperature of the heater 207 based on the temperature measured by a temperature sensor 208. Temperature control is performed by repeating on and off power supply to the heater 207 by connecting or disconnecting a switch 210. The switch 210 is switched between connected and disconnected states by changing the signal level of a switch control line (not shown).

In a case where the MFP 104 executes a scan function, a user sets an original on the scanner unit 203 and then operates related buttons on the operation unit 201 in accordance with the screen displayed on the operation unit 201. Through this, the user makes settings of the scan function and gives an instruction to start execution of the scan function. The scanner unit 203 optically reads the original and converts an image on the original into image data under the control of the main controller 202. The image data is temporarily stored in the main controller 202. Thereafter, the main controller 202 converts the stored image data into another data format as necessary and transfers the image data to a transmission destination designated in advance by the operation unit 201.

In a case where the MFP 104 executes a copy function, the user sets an original on the scanner unit 203 and then operates related buttons on the operation unit 201 in accordance with the screen displayed on the operation unit 201. Through this, the user makes settings of the copy function and gives an instruction to start execution of the copy function. The scanner unit 203 optically reads the original and converts an image on the original into image data under the control of the main controller 202. The image data is temporarily stored in the main controller 202. Thereafter, the main controller 202 converts the stored image data into another data format and transfers the image data to the printer unit 204. The printer unit 204 prints an image based on the transferred image data on recording paper and discharges the printed paper outside the apparatus. The power supply unit 205 is a power supply that converts the voltage of a commercial power source supplied from a power supply plug 206 into voltage used by various units of the MFP 104.

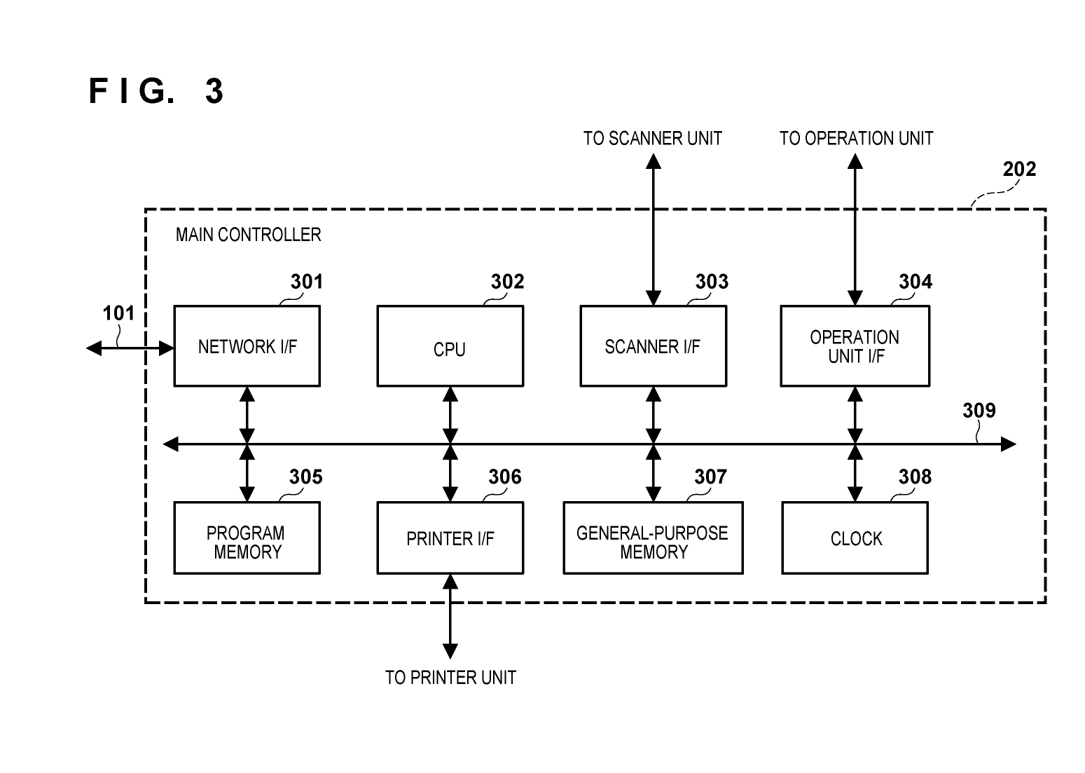

Detailed Configuration of Main Controller (FIG. 3)

The main controller 202 includes a network interface (I/F) 301, a CPU 302, a scanner I/F 303, an operation unit I/F 304, a program memory 305, a printer I/F 306, a general-purpose memory 307, and a clock 308. These constituent elements are connected one to another via an internal bus 309. The network I/F 301 performs communication via the network 101. The scanner I/F 303 performs communication with the scanner unit 203. The operation unit I/F 304 performs communication with the operation unit 201. The printer I/F 306 performs communication with the printer unit 204. The program memory 305 is a nonvolatile memory. The clock 308 is regularly corrected via the network using the Network Time Protocol (NTP) method, in order to maintain accuracy. The CPU 302 performs overall control of the main controller 202. The CPU 302 reads out a program from the program memory 305 and performs processing using the general-purpose memory 307 as a temporary storage area.

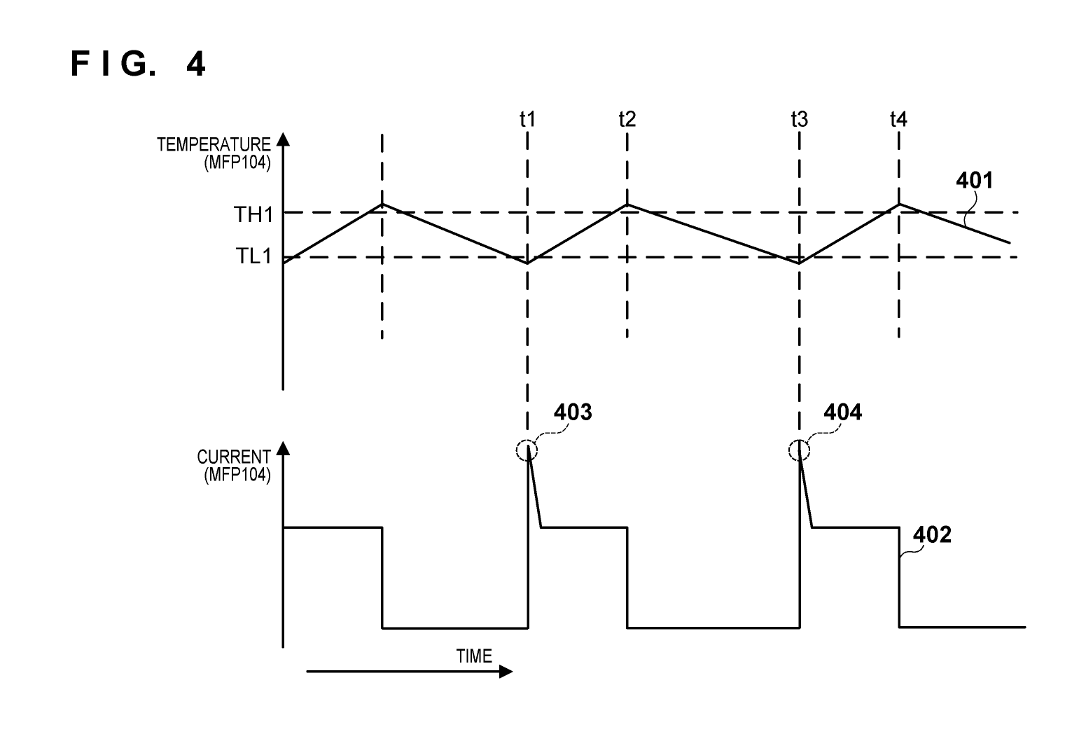

Transitions of Heater Temperature and Current Flowing in Heater Over Time (FIGS. 4 to 6)

FIG. 4 shows the transition state of the temperature of the heater of the MFP 104 and the transition state of current consumed by the heater. The horizontal axis indicates time, and the vertical axis indicates temperature or current. Reference numeral 401 denotes the temperature of the heater 207 that is read by the temperature sensor 208, and reference numeral 402 denotes the current flowing in the heater 207. TH1 denotes a threshold value that corresponds to an upper limit of the temperature of the heater 207, and TL1 denotes a threshold value that corresponds to a lower limit of the temperature of the heater 207. At times t1 and t3, since the temperature is lower than TL1, power supply to the heater 207 is turned on, whereas at times t2 and t4, since the temperature is higher than TH1, power supply to the heater 207 is turned off. This allows the heater 207 to maintain its temperature within a certain temperature range. Reference numerals 403 and 404 in the current waveform 402 denote inrush current flowing in the heater 207. The current value temporarily increases at times t1 and t3 when power supply to the heater 207 is turned on. The current value and the cycle between turning on and off power supply to the heater are not constant, and they vary depending on the outside temperature or whether or not recording paper is fed. They also vary greatly depending on the model of the MFP.

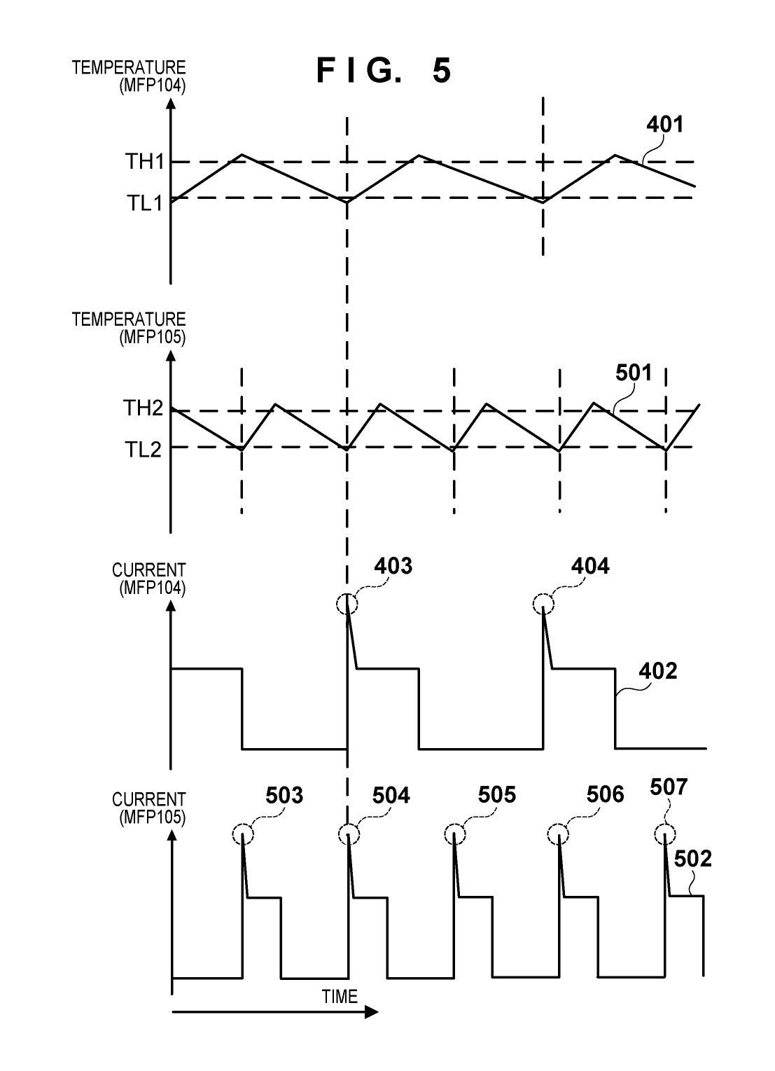

Next, a temperature waveform 501 and a current waveform 502 of the heater of the MFP 105 and the temperature waveform 401 and the current waveform 402 of the heater of the MFP 104 shown in FIG. 4 are presented side by side in FIG. 5. This enables comparison in the transition states of the heater temperature and the current flowing in the heater between the MFP 104 and the MFP 105. The heater 207 of the MFP 105 has different properties from that of the MFP 104. TH2 denotes a threshold value that corresponds to an upper limit of the temperature, and TL2 denotes a threshold value that corresponds to a lower limit of the temperature. As can be seen in the figure, the current value and the cycle between turning on and off power supply to the heater 207 differ greatly between the MFP 104 and the MFP 105. In the example of FIG. 5, the occurrence timing of inrush current 403 in the MFP 104 and the occurrence timing of inrush current 504 in the MFP 105 overlap each other, and accordingly, a total amount of current flowing in the two MFPs is extremely large. The present embodiment prevents such overlapping of occurrence timings of inrush current in multiple MFPs.

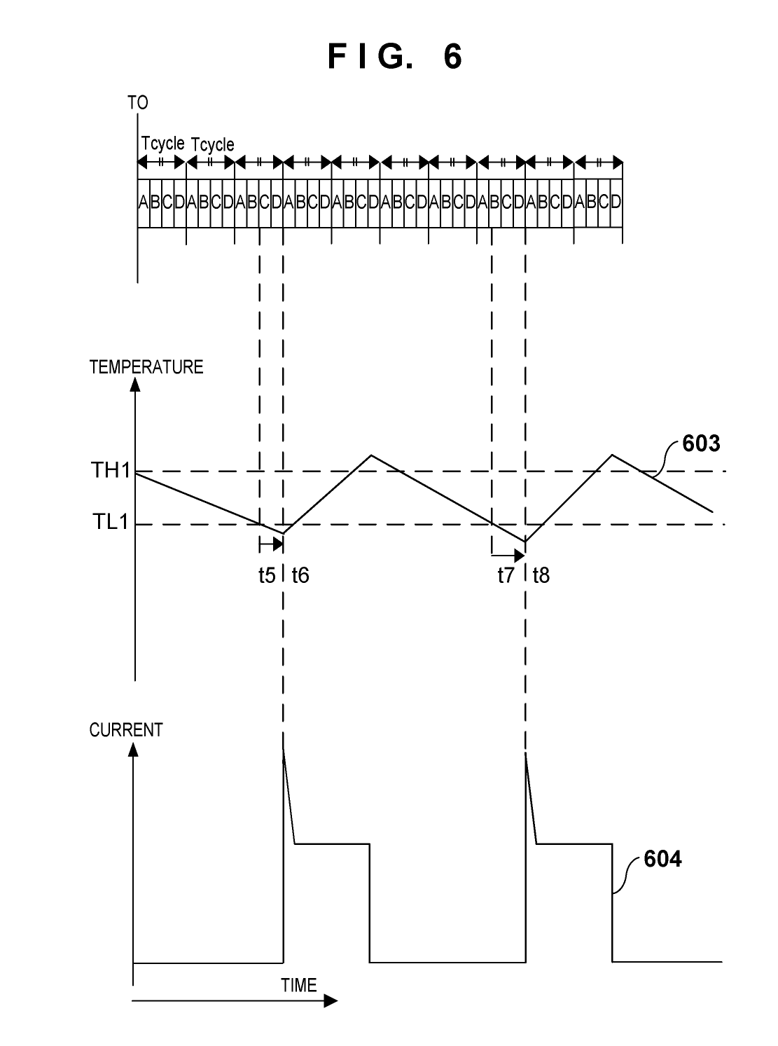

Next, FIG. 6 shows the transition state of the temperature of the heater 207 and the transition state of the current flowing in the heater 207 in the MFPs 104 and 105 according to the present embodiment. In the present embodiment, a description is given of the example in which a cycle Tcycle that is based on a reference time T0 and common among multiple MFPs is divided into multiple (in the present embodiment, four) time slots, and one of the four time slots is assigned to each of the MFPs as a time slot in which power supply to the heater 207 is allowed to be turned on. The MFP 104 receives, from the server 100, information on the reference time T0, the cycle Tcycle, and the time slot in which power supply to the heater 207 is allowed to be turned on. The time slot in which power supply to the heater 207 is allowed to be turned on is one of time slots A, B, C, and D. The server 100 assigns one of these time slots to each MFP such that the respective MFPs do not overlap in the same time slot as much as possible. A cycle Tcycle consisting of the four time slots A, B, C, and D is repeated periodically, such as A, B, C, D, A, B, C, D, A, and so on.

Here, a case where the time slot A is assigned to the MFP 104 will be described. Reference numeral 603 denotes a temperature waveform. At times t5 and t7, the temperature of the heater 207 falls below the predetermined threshold value TL1 for the MFP 104. However, since the time slot designated for the MFP 104 by the server 100 is A, turning on power supply to the heater is restrained until time slot A (that is, until time t6 or t8).

Note that, in the present embodiment, for the sake of simplification, a single cycle (cycle Tcycle) is divided into four equal time slots and one of the time slots is assigned to each MFP, but in the case where the server 100 manages a large number of MFPs, the cycle needs to be divided into further smaller time slots. The cycle Tcycle and the number of time slots into which the cycle is divided may be set in consideration of a period during which inrush current flows in the heater 207 and the accuracy of the clock 308 integrated in the MFP 104 or 105.

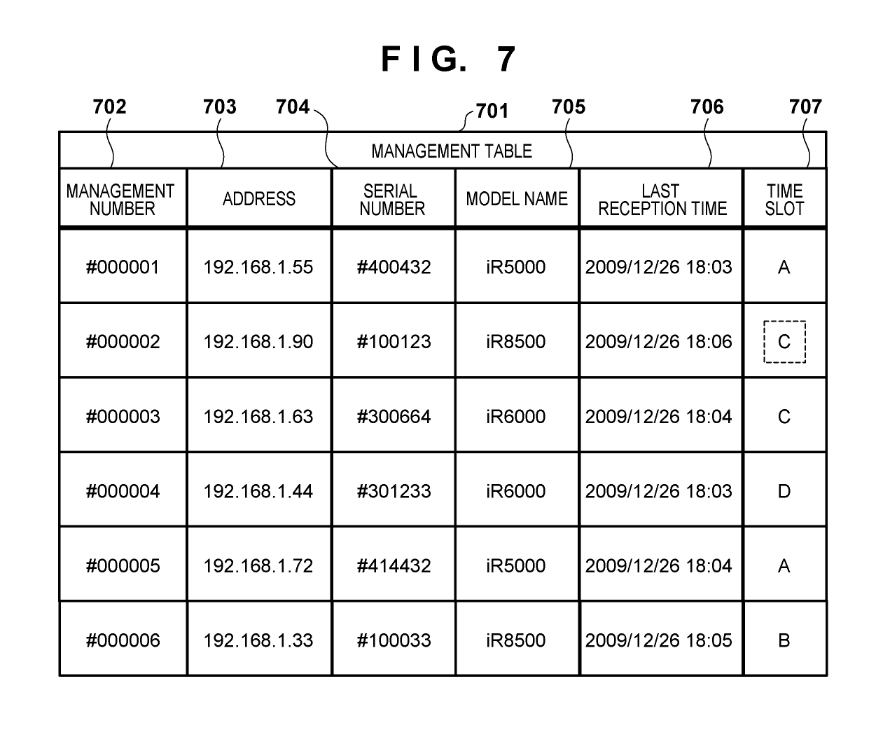

Example of Management Table (FIG. 7)

A management table 701 is referenced by the server 100 when notifying each MFP of the time slot in which power supply to the heater 207 is allowed to be turned on, and it is updated by the server 100 based on information received from MFPs being managed. Management number 702 represents a number that is assigned uniquely to each MFP being managed by the server 100. If a new MFP is detected, the server 100 assigns a new number to that MFP. The server 100 regularly receives a polling packet from each MFP. If a packet that contains information that does not match any of serial numbers 704 and model names 705 in the management table 701 is received, the sever 100 regards the MFP that is the transmission source of that packet as a new MFP. Address 703, serial number 704, and model name 705 are information that is extracted from the packet received from an MFP, and are used to identify each MFP. Last reception time 706 is a field for storing information indicating the latest time at which the server 100 has received information from the MFP. Each MFP regularly communicates with the server 100 and notifies the server 100 of its status that power is on. The server 100 updates the field of last reception time 706 every time it communicates with an MFP. Time slot 707 is a field for storing information indicating the time slot that the server 100 has assigned to each MFP in association with the MFP.

Processing Procedure Performed by Server

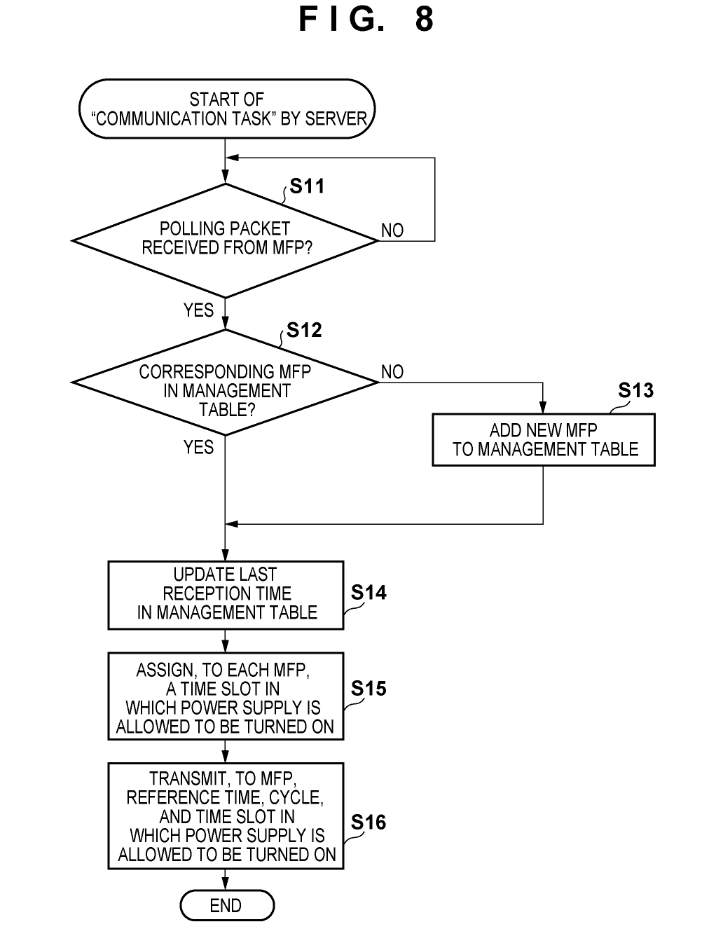

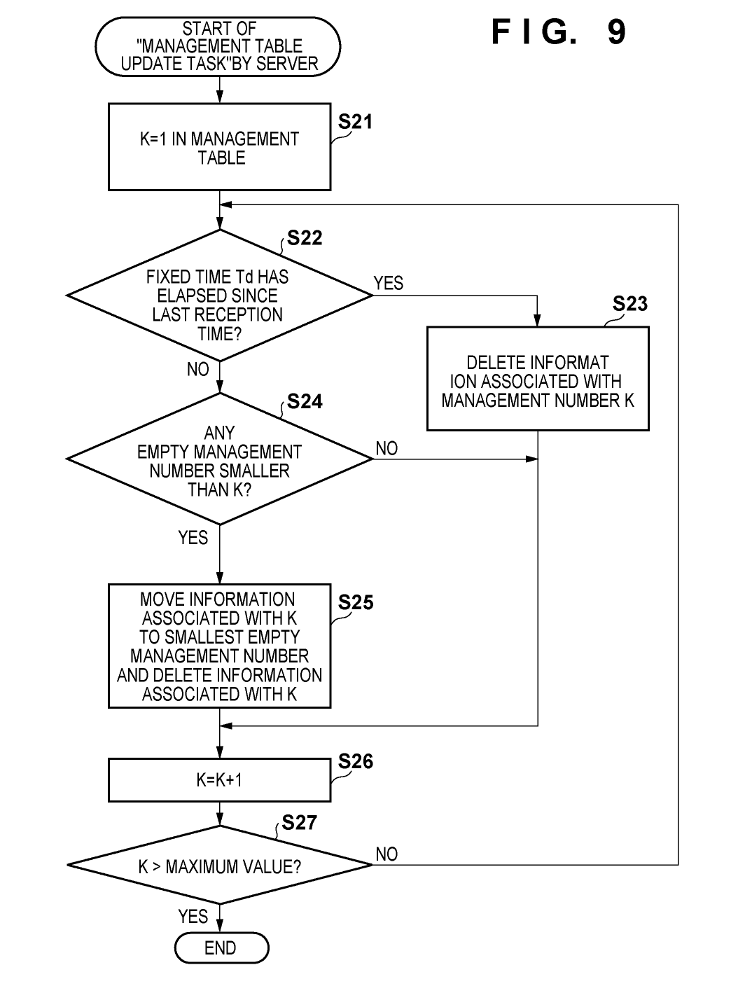

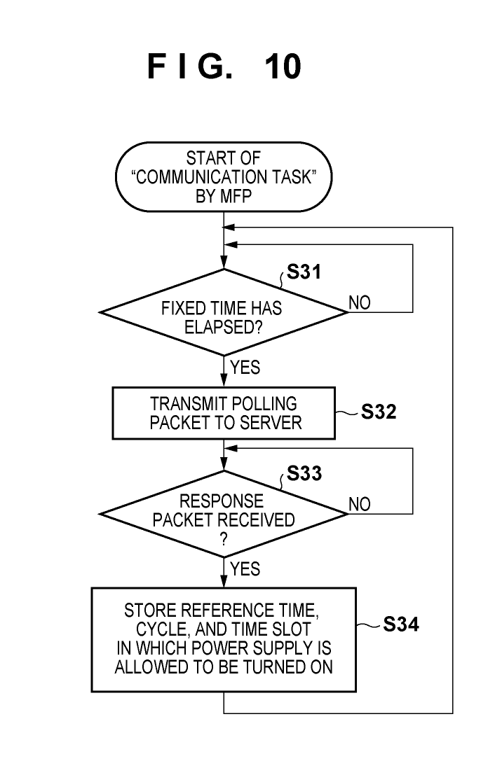

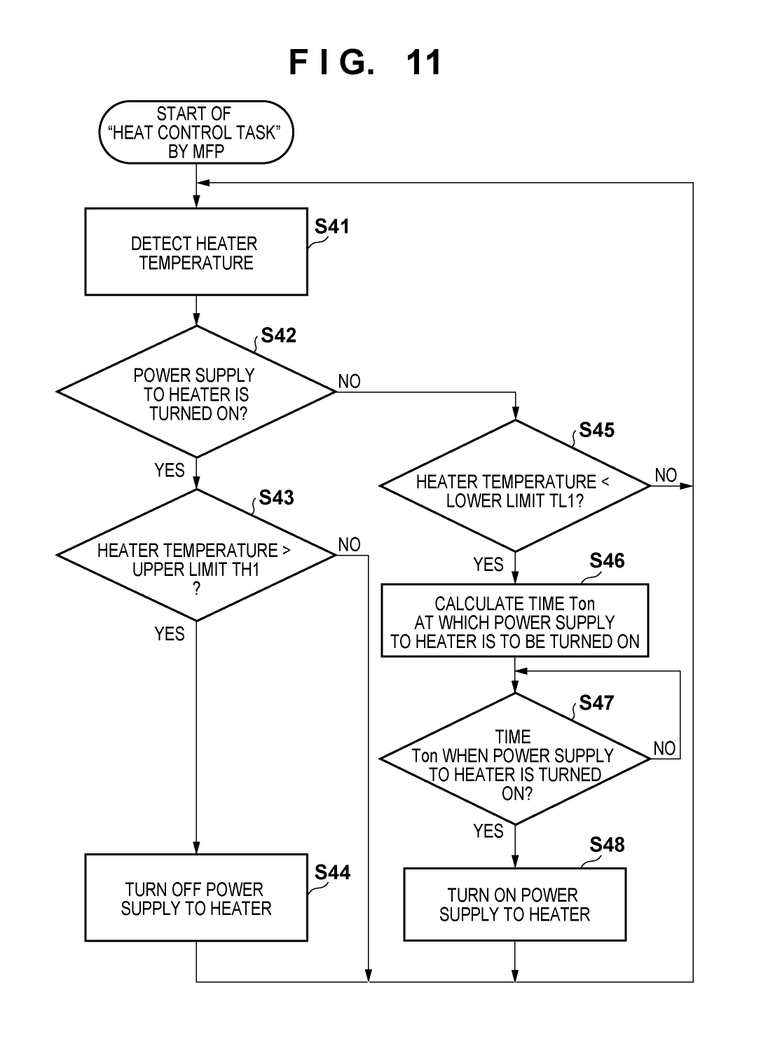

The server 100 performs multitasking of a communication task (FIG. 8) and a management table update task (FIG. 9). The MFP 104 performs multitasking of a communication task (FIG. 10) and a heater control task (FIG. 11). The following is a description of a processing procedure for each task.

Processing Procedure for Communication Task (FIG. 8)

The server 100 waits until a polling packet is received from an MFP (S11). The polling packet as used herein refers to a packet that is regularly transmitted from each MFP to the server 100. The polling packet includes the address, serial number, and model name of an MFP. Note that in a case where MFPs do not perform polling, corresponding information may be collected from the server 100 side.

If a polling packet is received, the server 100 determines whether or not the management table 701 (see FIG. 7) contains information on the MFP that transmitted the received polling packet (S12). If there is information on a corresponding MFP, the procedure proceeds to step S14. On the other hand, if there is no information on a corresponding MFP, the server 100 adds information of that MFP to the management table 701 (S13), and thereafter the procedure proceeds to step S14. Next, the server 100 updates the field of last reception time 706 in the management table 701 (S14). Then, the server 100 assigns a time slot in which power supply to the heater is allowed to be turned on to the MFP (S15). The method of assigning a time slot will be described later in detail. The server 100 then transmits, to the MFP, a packet that contains information indicating the reference time T0, the cycle Tcycle, and the time slot in which power supply is allowed to be turned on, as a response to the polling packet (S16).

Processing Procedure for Management Table Update Task (FIG. 9)

The management table update task is a task of regularly deleting MFPs from which a polling packet has not been received for a certain period of time, among the MFPs registered in the management table 701. If power is off, an MFP cannot transmit a polling packet. Since no inrush current will occur in an MFP whose power is off, the server 100 excludes that MFP from the MFPs targeted for management.

First, the server 100 sets a variable K that indicates the management number 702 to an initial value of 1 (S21). Then, the server 100 references the field of last reception time 706, which indicates the last time at which the polling packet has been received from the MFP whose management number 702 is the variable K, and determines whether or not a fixed period of time Td has elapsed since the last reception time (S22). If the fixed period of time Td has elapsed, the server 100 deletes the information associated with the management number K (S23), and thereafter the procedure proceeds to step S26. On the other hand, if the fixed period of time Td has not elapsed, the server 100 determines whether or not a number smaller than the management number K is available (S24). If a smaller number is not available, the procedure proceeds to step S26. On the other hand, if a smaller number is available, the server 100 moves the information associated with the management number K to the space with the available number, and deletes the information associated with the management number K (S25). Then, the server 100 increments the variable K (S26), and determines whether or not the value of K exceeds a maximum value (that is, whether or not all MFPs being managed have been updated) (S27). If the value exceeds the maximum value, a series of processes ends. On the other hand, if the value does not exceed the maximum value, the processing is repeated from step S22. Accordingly, even if a management number 702 becomes available, it is possible to close that space.

Processing Procedure Performed by MFP

Processing Procedure for Communication Task (FIG. 10)

The communication task performed by an MFP includes the following two processes: (1) the process of transmitting a polling packet to the server 100 via the network I/F 301 at fixed time intervals under the control of the CPU 302, and (2) the process of receiving a response packet from the server 100, extracting an instruction indicating the reference time T0, the cycle Tcycle, and the time slot in which power supply to the heater is allowed to be turned on, which are included in the response packet, and storing the instruction in the general-purpose memory 307.

First, the MFP waits until a fixed period of time has elapsed (S31). If a fixed period of time has elapsed, the MFP transmits a polling packet to the server 100 (S32). As previously described, in the present embodiment, the polling packet includes information on the address, serial number, and model name of the MFP. Then, the MFP waits until a response packet is received from the server 100 (S33), and upon receipt of the response packet, the MFP stores information on the reference time T0, the cycle Tcycle, and the time slot in which power supply to the heater is allowed to be turned on from the received response packet into the general-purpose memory 307 of the main controller 202 (S34).

Processing Procedure for Heater Control Task (FIG. 11)

The heater control task is a task of, under the control of the CPU 302, reading the temperature of the heater 207 with the temperature sensor 208 and controlling power supply to the heater 207 such that the temperature is within a fixed temperature range. However, in the case of turning on power supply to the heater 207, turning on of power supply to the heater 207 is restrained until the time instructed by the server 100 is reached.

First, the MFP detects the temperature of the heater 207 with the temperature sensor 208 (S41). Then, the MFP determines whether or not power supply to the heater 207 is ON (S42). If power supply is ON, the MFP determines whether or not the temperature detected in step S41 exceeds the upper limit TH1 (S43). If the temperature exceeds the upper limit, the MFP turns off power supply to the heater 207 (S44), and the procedure continues the processing from step S41. On the other hand, if the temperature does not exceed the upper limit TH1, the MFP maintains the ON state of power supply to the heater 207, and the procedure continues the processing from step S41.

In step S42, if power supply to the heater 207 is OFF, the MFP determines whether or not the temperature detected in step S41 is lower than the lower limit TL1 (S45). In other words, it is determined whether or not criteria, set in advance for each of multiple MFPs, for turning on power supply to the heater 207 are satisfied. If the detected temperature is not lower than the lower limit TL1, the MFP maintains the OFF state of power supply to the heater 207, and the procedure continues the processing from step S41. On the other hand, if the temperature is lower than the lower limit, the MFP calculates a time Ton at which power supply to the heater 207 is to be turned on (S46). Then, the MFP waits until the time Ton at which power supply to the heater 207 is to be turned on is reached (S47), and then at the time Ton, turns on power supply to the heater 207 (S48). Thereafter, the procedure continues the processing from step S41.

The time Ton at which power supply to the heater is to be turned on is calculated from Equation (1) below, using a delay time Tdelay that corresponds to the information on the reference time T0, the cycle Tcycle and the time slot received from the server 100.

Ton=T0+Tcycle×n+Tdelay (1)

Here, n is the smallest integer not less than zero for correcting the time Ton such that Ton is not a past time. The reference time T0 needs to be a past time. For example, the reference time T0 is “2010/1/1 0:00”. As a delay time Tdelay, for example, the CPU 302 calculates 0 if the notified time slot is A, Tcycle/4 for the time slot B, Tcycle/2 for the time slot C, or Tcycle×¾ for the time slot D, and substitutes the calculated delay time into Equation (1). Note that the server 100 may notify each MFP of the value of the delay time Tdelay, instead of the time slot (A to D). In the present case, Tdelay notified by the server is itself substituted into Equation (1), and Ton is calculated. In this way, the value of Tdelay varies depending on the time slot (A to D) notified by the server 100. Accordingly, it is possible to appropriately stagger the timings at which multiple MFPs turn on power supply to the heaters 207 and thereby reduce overlapping of occurrence timings of inrush current due to the transition of power supply to the heater 207 from OFF to ON.

As described above, if the criteria for turning on power supply to the heater 207 are satisfied, the CPU 302 performs control such that power supply to the heater is turned on when the time slot notified by the server 100 is reached.

Next is a description of the method for assigning a time slot in which power supply to the heater is allowed to be turned on. As previously described, in the present embodiment, the cycle Tcycle is divided into four equal time slots A, B, C, and D, and one of the time slots is assigned to each MFP. This assignment method includes the following two steps: (1) the step of counting the number of MFPs to which each time slot is assigned, using all MFPs excluding the MFP to which a time slot is currently to be assigned, and (2) the step of determining a time slot for which the smallest number of MFPs are assigned and setting that time slot as a time slot assigned to the current target MFP. If there are two or more time slots for which the smallest number of MFPs are assigned, one of these time slots is set.

For example, a description is given of the case where a target MFP has the management number #000002 in the example of the management table 701 shown in FIG. 7. When the number of MFPs assigned for each time slot is counted, using MFPs other than the MFP with the management number #000002, the result shows that the number of MFPs assigned for the time slot A is two, and the number of MFPs assigned for each of the time slots B, C, and D is one. Accordingly, B, C, and D are the time slots for which the smallest number of MFPs is assigned. Thus, one of the time slots B, C, and D (in the present example, C) is assigned to the MFP with the management number #000002. The assigned time slot is set in the corresponding field of time slot 707 in the management table 701.

Next is a description of a method for determining the cycle Tcycle that is set in advance by the server 100, and the number of time slots into which the cycle is divided. In the present embodiment, the cycle Tcycle is divided into four, but the number of time slots may be determined arbitrarily. By appropriately determining the number of time slots, it is possible, particularly in the case where a large number of MFPs are being managed, to enhance the effect of reducing overlapping of occurrence timings of inrush current. However, the number of time slots into which the cycle Tcycle is divided needs to be determined in consideration of a clock error and the period during which inrush current flows. This is because, if the number of time slots is increased, there will be a smaller difference in the amount of time by which power supply to the heater 207 is delayed among MFPs, and accordingly occurrence timings of inrush current will possibly overlap. This problem may be avoided if the cycle Tcycle is lengthened, but on the other hand, it may incur the possibility of increasing the period of time during which turning on of power supply to the heater 207 is restrained and the possibility that the temperature of the heater 207 may become too low during that restraint period. Taking all of these points into consideration, the cycle Tcycle and the number of time slots into which the cycle is divided need to be set appropriately.

As described above, by determining the reference time T0, the cycle Tcycle, and the time slot in which power supply to the heater 207 is allowed to be turned on and assigning, to each MFP, a time slot in which power supply is allowed to be turned on, the server 100 is capable of reducing overlapping of occurrence timings of inrush current in multiple MFPs.

Note that, in the present embodiment, the reference time T0 is a fixed value indicating date and time, but the server 100 may omit high-order values such as year, month, and day. This reduces the number of digits used for each MFP to calculate the time at which power supply to the heater is turned on from Equation (1), thus simplifying the calculation. Furthermore, the server 100 may regularly change the reference time T0 in order to reduce a difference between the reference time T0 and the current time. This makes the value of n small in Equation (1), thus simplifying the calculation.

### Embodiment 2

In Embodiment 1, all MFPs are handled without discrimination in determining their time slots in which power supply to the heater 207 is allowed to be turned on, but actually the amount of inrush current occurring in each MFP differs greatly depending on the type and state of the MFP. Also, there are cases where the number of MFPs is greater than the number of time slots into which the cycle Tcycle is divided. For this reason, in the case where the same time slot is assigned to multiple MFPs, it may be desirable, for the time slot to be assigned, to be determined based not on the number of MFPs but the amount of inrush current. Accordingly, in the present embodiment, an example will be described in which the amount of inrush current occurring in an MFP is considered in determining the time slot in which power supply to the heater 207 is allowed to be turned on.

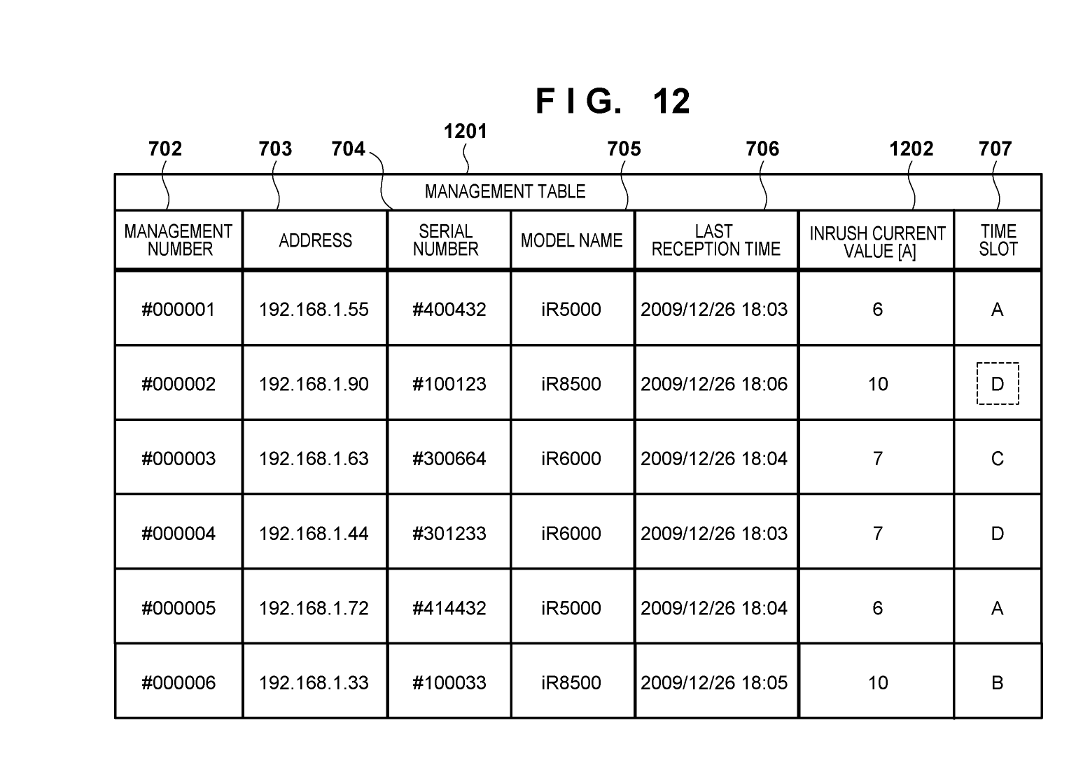

Example of Management Table (FIG. 12)

A management table 1201 according to the present embodiment can be generated by adding the field of inrush current value 1202 to the management table 701 of Embodiment 1 shown in FIG. 7. Here, information on the inrush current value is contained in the polling packet transmitted from an MFP being managed to the server 100, and is stored in the management table 1201 by the server 100 that has received that packet.

A description is given of a method for assigning a time slot in which power supply to the heater 207 is allowed to be turned on. In the present embodiment, as in Embodiment 1, the cycle Tcycle is divided into four equal time slots A, B, C, and D, and one of these time slots is assigned to each MFP. This assignment method includes the following steps: (1) the step of summing up the inrush current values 1202 of MFPs assigned for each time slot, using all MFPs excluding the MFP to which a time slot is currently to be assigned, and (2) the step of setting a time slot having the smallest total value of the inrush current values being summed up as a time slot to be assigned to the target MFP. If there are two or more time slots having the smallest total value of the inrush current values 1202, one of these time slots is set.

For example, a description is given of the case where the target MFP has the management number #000002 in the example of the management table 1201 shown in FIG. 12. If the inrush current values of MFPs assigned for each time slot is summed up using all MFPs other than the MFP with the management number #000002, the result shows that the total inrush current value for the time slot A is 12 A (two MFPs), the total inrush current value for the time slot B is 10 A (one MFP), the total inrush current value for the time slot C is 7 A (one MFP), and the total inrush current value for the time slot D is 7 A (one MFP). Accordingly, C and D are the time slots having the smallest total inrush current value. Thus, one of the time slots C and D (in the present example, D) is assigned to the MFP with the management number #000002. The assigned time slot is set in the corresponding field of the time slot 707 in the management table 1201.

As described above, the server 100 is capable of assigning time slots such that the sum of the inrush current values of MFPs assigned for the same time slot is minimized for each time slot. Accordingly, it is possible to reduce the amount of inrush current even if the occurrence timings of inrush current in multiple MFPs overlap.

Note that Embodiments 1 and 2 describe examples in which, in OA equipment such as the MFP 104 or 105, the printer 106, or the FAX 107, overlapping of occurrence timings of inrush current is reduced by controlling power supply to the heater 207. However, a target for control of power supply may be other than the heater 207. For example, the present invention is also applicable to an apparatus including a device such as a compressor that compresses air, or an apparatus that switches between an energy-saving mode and a normal mode. In particular, with recent offices, a communication system in which the server 100 turns on or off the energy-saving mode of OA equipment is realized. In such a communication system, a case is conceivable in which multiple pieces of OA equipment will be all transitioned from the energy-saving mode to the normal mode at the start of the working day. The mechanism for staggering the timings of turning on power supply according to the present invention is also applicable to such a communication system.

The server 100 may be provided on the same network as apparatuses to be controlled, or may be provided on a different network connected via the Internet or the like. Alternatively, one of multiple apparatuses may be provided with the function of the server 100, and the apparatuses may operate in cooperation with one another to realize the aforementioned operation without having an independent server 100. Furthermore, the server 100 may check the MFPs.

In the present embodiment, a description is given of the example in which the server 100 is notified of the inrush current value from each MFP, but a configuration is also possible in which the server 100 may be notified by each MFP of only model information on the MFP, and the notified model information may be converted into a corresponding inrush current value on the server 100 side.

Furthermore, each MFP may notify the server of a current consumption value for the MFP or its heater 207, instead of the inrush current value. Since the inrush current value is often proportional to the current consumption value, it is possible to calculate the inrush current value from the current consumption value.

### Embodiment 3

In the example described in Embodiment 1, since the cycle Tcycle is divided into four time slots, if there are five or more MFPs, the same time slot will be assigned to multiple MFPs. In this case, there is a possibility that the MFPs assigned for the same time slot may have overlapping occurrence timings of inrush current. Thus, the present embodiment is devised so that the number of time slots into which the cycle Tcycle is divided will not be less than the number of MFPs. In a case where a new MFP is detected, the server 100 compares the number of MFPs and the number of time slots into which the cycle Tcycle is divided. If the number of time slots is lower than the number of MFPs, the server 100 increases the number of time slots into which the cycle Tcycle is divided such that the cycle Tcycle is divided into the same number of time slots as the number of MFPs. In other words, the server 100 generates the same number of time slots as the total number of MFPs. Furthermore, the server 100 assigns one of the time slots to each of the MFPs such that none of the time slots assigned to the MFPs overlap.

Processing Procedure Performed by Server

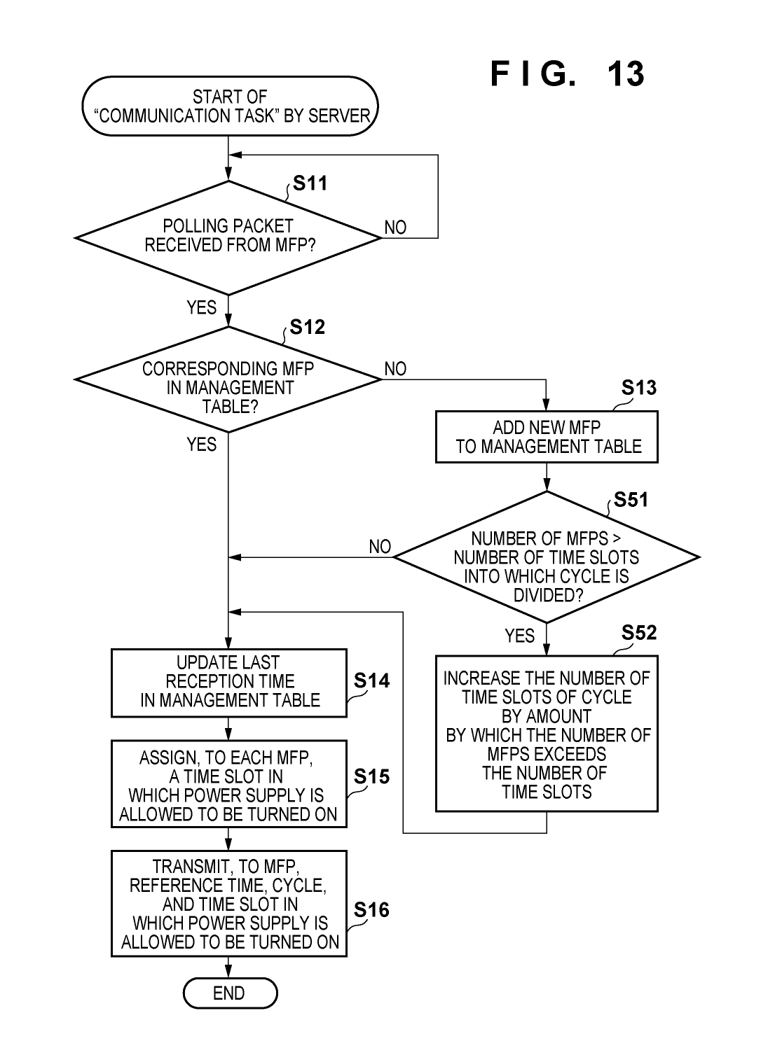

Processing Procedure for Communication Task (FIG. 13)

FIG. 13 is substantially the same as FIG. 8 described in Embodiment 1, but differs only in that processing to be performed in the case where the management table 701 does not contain information on the MFP that is the transmission source of the polling packet is added to the procedure. In this case, after adding a new MFP to the management table 701 (S13), the server 100 determines the number of MFPs being managed and compares the number of MFPs with the number of time slots into which the cycle Tcycle is divided (S51). If the number of MFPs does not exceed the number of time slots into which the cycle Tcycle is divided, the server 100 continues the procedure from the processing of step S14. On the other hand, if the number of MFPs exceeds the number of time slots, the server 100 increases the number of time slots into which the cycle Tcycle is divided, by the amount by which the number of MFPs exceeds the number of time slots (S52), and thereafter the procedure continues the processing from step S14.

Accordingly, even if the number of MFPs being managed by the server 100 increases, it is possible to prevent each time slot from being assigned to multiple MFPs, thus avoiding overlapping of occurrence timings of inrush current in multiple MFPs.

As described above, according to the present embodiment, the cooperative operation of the server 100 and MFPs that are being managed and in which inrush current occurs reduces the possibility that the occurrence timings of inrush current in multiple MFPs will overlap.

In a conventional communication system, in the case where each apparatus individually controls its heater and apparatuses of different models coexist, it is necessary to take into consideration the fact that the cycle of switching between turning on and off the power supply to the heater differs greatly from apparatus to apparatus. Therefore, it has been difficult to set a constant cycle between turning on and off of power supply for all apparatuses. However, according to the present invention, even if the above cycle differs from apparatus to apparatus, it is possible to stagger the timings at which multiple apparatuses turn on power supply to their heaters.

Furthermore, a conventional communication system has a problem in that the amount by which the timings of turning on power supply in multiple apparatuses are staggered cannot be increased with an increase in the number of apparatuses. For example, in the case where there are 100 apparatuses each having a 10-second cycle of switching between turning on and off of power supply to the heater, theoretically 0.1 seconds are assigned to each of the apparatuses as a period of time in which power supply to the heater is allowed to be turned on. However, assigning a period of time as short as 0.1 seconds to each apparatus is difficult to achieve due to the following two problems. One problem is that as many as 100 apparatuses have to be controlled with high accuracy for such a period of time as short as 0.1 seconds. The other problem is that an apparatus with multiple internal heaters has a short period of time to control power supply to its heaters in order. According to the present invention, it is possible to cope with this by setting the amount, by which the timings of turning on power supply to heaters in multiple apparatuses are staggered, to a fixed value or higher.

A conventional communication system further has the problem of distance. In large offices, MFPs are located far apart and therefore communication using a private line is difficult. Thus, it is desirable that MFPs can be controlled through general network communication using an Ethernet (registered trademark) or the like. However, since packet transmission delays occur in the network, it is difficult to bring MFPs into synchronization with one another with high accuracy. According to the present invention, because each MFP uses a regularly adjusted clock, it is possible to bring MFPs into synchronization with one another with high accuracy.

A conventional communication system further has a problem in that the number of MFPs increases or decreases. There are cases where, depending on the processing status of a job in an MFP or the state of a heater, the MFP may transition to a state in which it stops controlling the heater, and accordingly may be excluded from targets to be controlled by the server. On the contrary, there are also cases where an MFP may transition from the state in which it stops controlling the heater to a state in which it controls the heater, and accordingly may be included in the targets to be controlled by the server. According to the present invention, because the amount by which the timings of turning on power supply to heaters are staggered can be controlled in accordance with the operating status of each MFP, it is possible to maintain the appropriate control state even if the number of apparatuses to be controlled by the server changes.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-219764, filed Sep. 29, 2010, which is hereby incorporated by reference herein in its entirety.

What is claimed is:

1. A communication system that includes a server and a plurality of apparatuses and in which each of the plurality of apparatuses controls, in accordance with an instruction from the server, a state of power supply to a device integrated in the apparatus,
the server comprising:
an assignment unit that assigns one of a plurality of time slots that are repeated periodically to each of the plurality of apparatuses, and
a notification unit that notifies each of the plurality of apparatuses of information indicating the time slot assigned by the assignment unit, and
each of the plurality of apparatuses comprising:
a control unit that, in a case where a pre-set criterion for each of the plurality of apparatuses to turn on power supply to the device is satisfied and where a time slot in which the criterion has been satisfied is the time slot notified by the notification unit, turns on power supply to the device upon satisfaction of the criterion, and in a case where the criterion is satisfied and where the time slot in which the criterion has been satisfied is not the notified time slot, turns on power supply to the device upon reaching the notified time slot after satisfaction of the criterion.

2. The communication system according to claim 1, wherein the assignment unit assigns one of the plurality of time slots to each of the plurality of apparatuses so as to reduce a difference between the plurality of time slots in the number of apparatuses to which each of the time slots is assigned.

3. The communication system according to claim 1, wherein the assignment unit assigns one of the plurality of time slots to each of the plurality of apparatuses so as to reduce a difference between the plurality of time slots in a sum of values of inrush current flowing in the devices of the apparatuses to which each of the time slots is assigned.

4. The communication system according to claim 1, wherein
the assignment unit includes a generation unit that generates the same number of the time slots as the number of apparatuses, and
the assignment unit assigns one of the plurality of time slots generated by the generation unit to each of the plurality of apparatuses without the respective time slots assigned to the plurality of apparatuses overlapping.

5. The communication system according to claim 1, wherein
each of the plurality of apparatuses is an image forming apparatus, wherein
the device is a heater for performing image forming, and
the control unit restrains turning on of power supply to the device until the time slot notified by the notification unit is reached, even if a temperature of the heater is lower than a threshold value for turning on power supply to the heater after turning off of power supply to the heater.

6. The communication system according to claim 1, wherein
the server further comprises:
a collection unit that collects information for specifying the plurality of apparatuses from each of the apparatuses; and
a management table in which the information collected by the collection unit is stored,
the assignment unit assigns one of the plurality of time slots to each of the plurality of apparatuses without an overlap, and stores the time slots assigned to the apparatuses in the management table in association with the information collected by the collection unit, and
the notification unit notifies each of the plurality of apparatuses of information indicating the time slot stored in the management table.

7. A control method for a communication system that includes a server and a plurality of apparatuses and in which each of the plurality of apparatuses controls, in accordance with an instruction from the server, a state of power supply to a device integrated in the apparatus, the method comprising:
in the server,
assigning one of a plurality of time slots that are repeated periodically to each of the plurality of apparatuses, and
notifying each of the plurality of apparatuses of information indicating the assigned time slot assigned in the assigning, and
in each of the plurality of apparatuses,
in a case where a pre-set criterion for each of the plurality of apparatuses to turn on power supply to the device is satisfied and where a time slot in which the criterion has been satisfied is the time slot notified in the notifying, turning on power supply to the device upon satisfaction of the criterion, and in a case where the criterion is satisfied and where the time slot in which the criterion has been satisfied is not the notified time slot, turning on power supply to the device upon reaching the notified time slot after satisfaction of the criterion.
